(19) United States
(12) Patent Application Publication
(10) Pub. No.: US 2014/0351054 A1
(43) Pub. Date: Nov. 27, 2014

(54) ADVERTISEMENT APPARATUS AND ADVERTISEMENT SERVICE PROVIDING METHOD BASED ON LOCATION BASED SERVICE AND BROADCASTING

(71) Applicant: Electronics and Telecommunications Research Institute, Daejeon (KR)

(72) Inventors: Chung Hyun Ahn, Daejeon (KR); Sung Hoon Kim, Daejeon (KR)

(73) Assignee: Electronics and Telecommunications Research Institute, Daejeon (KR)

(21) Appl. No.: 14/025,242

(22) Filed: Sep. 12, 2013

(30) Foreign Application Priority Data
May 21, 2013 (KR) 10-2013-0056868

(51) Int. Cl. G06Q 30/02

(52) U.S. Cl. CPC G06Q 30/0266
USPC 705/14.63

(57) ABSTRACT

There are provided an advertisement device combining an LBS (Location Based Service) with broadcast and a method of providing an advertisement service using the same. The advertisement device comprises a location information obtaining unit configured to obtain location information of a vehicle, a broadcast signal receiving unit configured to receive a broadcast signal including advertisement information through a broadcast network, an advertisement information storing unit configured to store the advertisement information included in the broadcast signal, and a controller configured to enable the advertisement information corresponding to the location information to be displayed through a displaying device installed inside or outside the vehicle.

Priority to Korean patent application number 10-2013-0056868 filed on May 21, 2013, the entire disclosure of which is incorporated by reference herein, is claimed.

### BACKGROUND OF THE INVENTION

1. Technical Field

Embodiments of the present invention are directed to mobile/stationary advertisement systems combining real time/non-real time advertisement transmission with location information using a broadcast network and methods of providing advertisement services.

2. Discussion of the Related Art

In the era of smart phones, location information providing technology enables various location based services (LBSs). By way of example, GPS (Global Positioning System) signals may be used for outdoor locating, and base stations or WiFi (Wireless-Fidelity) may be used to pinpoint the indoor location within a radius of a few meters. Accordingly, various technologies are being developed to provide proper advertisement services based on users' locations.

As an example, Korean Patent Application Publication No. 10-2006-0113135 (publication date: Nov. 2, 2006) titled “method and system of advertising franchise stores in a car navigation service,” discloses a method in which if a subscriber of a franchise advertisement service sets the type of service and destination information using a PSS (Personal Subscriber Station), the PSS accesses a driving information service server through a wireless access network to request a driving information service, downloads packet data of the driving information, stores it in the Nate Drive Kit™ of the vehicle, provides it to users in a predetermined service form, and when the subscriber coming to pass through an area where the franchise store has requested advertisement while receiving the driving information service, provides the subscriber with advertisement services.

However, such a method of providing advertisement services may provide advertisements to only a few people such as the vehicle's driver or passengers, and thus fails to provide many unspecified persons as television advertisements or outdoor advertisements do. Accordingly, the advertisements are not that effective.

Meanwhile, some vehicles such as buses or taxies drive with advertisements attached thereon. Such advertisements may attract the interest of a number of unspecified people. However, the advertisements are stuck or printed onto the vehicle, and this renders it difficult to provide unique advertisement for each area.

Therefore, there is a need for a method that may provide proper advertisements to multiple unspecified persons per area using a stationary advertisement device or an advertisement device attached to the inside or outside of the vehicle, may update advertisements more easily, and may maximize the effect of advertisement.

### SUMMARY

An object of the present invention is to provide an advertisement device combining an LBS with broadcast and a method of providing an advertisement service using the same, which may provide per-area advertisement to multiple unspecified persons through a stationary/mobile advertisement device and may more easily update the advertisements.

Another object of the present invention is to provide an advertisement device combining an LBS with broadcast and a method of providing an advertisement service using the same, which may maximize the advertisement effect by providing consumers with advertisements customized per area, per date, or per hour through a mobile/stationary advertisement device.

According to an aspect of the present invention, an advertisement device providing an advertisement service depending on location, the advertisement device may comprise a location information obtaining unit configured to obtain location information of a vehicle, a broadcast signal receiving unit configured to receive a broadcast signal including advertisement information through a broadcast network, an advertisement information storing unit configured to store the advertisement information included in the broadcast signal, and a controller configured to enable the advertisement information corresponding to the location information to be displayed through a displaying device installed inside or outside the vehicle.

According to an embodiment of the present invention, the advertisement device may be installed inside or outside the vehicle, and the displaying device may be a thin film-type flexible displaying device.

According to another embodiment of the present invention, the advertisement information may be in real time extracted from the broadcast signal received through the broadcast network during a test signal time and may be stored.

According to still another embodiment of the present invention, the controller may comprise a determining module configured to determine whether the advertisement information corresponding to the location information is stored in the storing unit, a requesting module configured to, in a case where the advertisement information corresponding to the location information is not stored in the storing unit, sends a request for the advertisement information corresponding to the location information to an advertisement server through a communication network, and a transmission module configured to transmit the advertisement information received from the advertisement server to the displaying device so that the advertisement information corresponding to the location information is displayed through the displaying device.

According to yet still another embodiment of the present invention, the controller may enable the advertisement information corresponding to the location information to be displayed through the displaying device installed inside the vehicle.

According to another aspect of the present invention, a method of providing an advertisement service depending on location may comprise obtaining location information of a vehicle by an advertisement device, receiving a broadcast signal including advertisement information through a broadcast network, storing the advertisement information included in the broadcast signal, and enabling the advertisement information corresponding to the location information to be displayed through a displaying device installed outside the vehicle.

Based on the advertisement information included in a broadcast signal, proper advertisements per season, per hour, per age, or per consumer may be provided depending on the position of the advertisement device. Accordingly, a different advertisement may be provided in a different area, and the advertisements may be renewed more easily.

Based on the location information of the advertisement device or time information related to consumption patterns, when a vehicle is on the move, a display device provided in the inside/outside of a vehicle may be used to expose advertisements that fit into the area, date, or time, thus winning advertisers the maximized advertisement effect.

### BRIEF DESCRIPTION OF THE DRAWINGS

FIG. 1 is a view illustrating an advertisement system according to an embodiment of the present invention;

FIG. 2 is a block diagram illustrating an advertisement device according to an embodiment of the present invention;

FIGS. 3 and 4 are views illustrating displaying devices displaying advertisement information according to embodiments of the present invention; and

FIG. 5 is a flowchart illustrating a method of providing an advertisement service depending on location according to an embodiment of the present invention.

### DETAILED DESCRIPTION OF EMBODIMENTS

Embodiments of the present invention will be described in detail with reference to the accompanying drawings so that the present invention may be easily made by those of ordinary skill in the art. However, the present invention may be embodied in many different ways, and is not limited thereto. What is not relevant to the present invention has been skipped from the detailed description in order to clarify the present invention, and similar reference denotations are used to refer to similar elements throughout the specification.

As used herein, when an element “includes” another element, the element does not exclude other elements unless stated otherwise, and rather may further include other elements. As used herein, the term “ . . . unit” refers to a basis for processing at least one function or operation and may be implemented in software, hardware, or in a combination thereof.

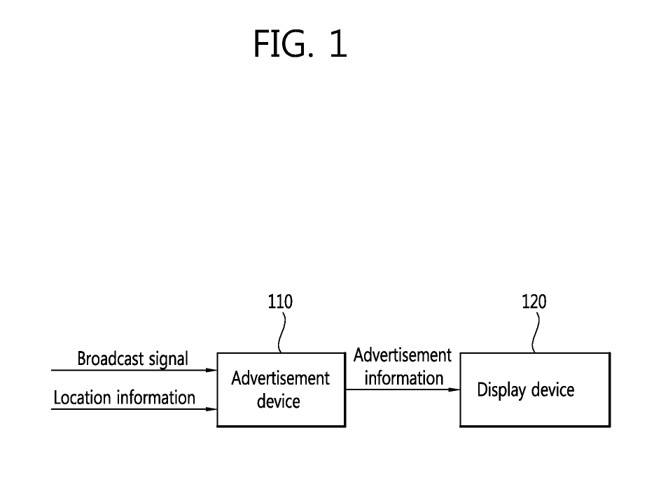

FIG. 1 is a view illustrating an advertisement system according to an embodiment of the present invention.

The advertisement system according to the present invention may include an advertisement device 110 and a display device 120 as shown in FIG. 1 so as to provide an advertisement service depending on the position of a vehicle.

The advertisement device 110 is installed in a vehicle such as a bus or taxi and obtains location information of the vehicle. The advertisement device 110 receives a broadcast signal including advertisement information through a broadcast network and stores the advertisement information included in the broadcast signal.

By way of example, the advertisement device 110 according to the present invention may, in real time, extract the advertisement information from the transmitted broadcast signal using NRT (Non-Real Time) transmission technology that previously downloads necessary content to the receiver during a test signal time during which no program is broadcast and may store the extracted advertisement information, and the advertisement device 110 may receive desired advertisement information through a broadcast network as necessary even during an on-air time during which a normal program is broadcast.

Meanwhile, the advertisement device 110 according to the present invention may obtain the location information of the vehicle where the advertisement device 110 is installed based on GPS information received from the GPS (Global Positioning System) or WiFi information received from a WiFi AP (Wireless Fidelity Access Point) installed on the road or station and may go on grasping the current location thereof. The advertisement device 110 may also grasp whether advertisement information corresponding to the current location information is present in the advertisement information extracted from the broadcast signal and stored. For such purpose, the advertisement device 110 may include a GPS receiver, a WiFi communication device, a tuner, and a storage device.

At this time, in case advertisement information corresponding to the location information is determined to be present, the advertisement device 110 may control the corresponding advertisement information to be displayed through the display device 120 installed in the inside and/or outside of the vehicle, so that the advertisement may be exposed through the inside/outside of the vehicle. For such purpose, the advertisement device 110 may include, e.g., an AV (Audio/Video) player and a display controller.

However, unless the advertisement information corresponding to the location information is determined to be present, the advertisement device 110 may send a request for advertisement information corresponding to the location information to an advertisement server through a communication network and download it or may control advertisement information transmitted from the advertisement server in the form of streaming to be displayed through the display device 120. Here, an example of the display device 120 installed in the outside of the vehicle may be a film-type flexible display. The advertisement server may previously download and store advertisement information through a broadcast network.

Meanwhile, the advertisement device 110, in case a plurality of advertisement information corresponding to the location information is detected among the previously stored advertisement information, may select advertisement information to be displayed through the display device 120 among the searched advertisement information based on time related to users' consuming patterns or current date, thereby enabling the advertisements to be exposed to a number of unspecified persons more effectively.

The above-described advertisement device 110 may be included in a vehicle such as bus or taxi. In such case, the vehicle includes an advertisement device that performs control to obtain the location information of the vehicle, to receive advertisement information through a broadcast network and store advertisement information included in the broadcast signal and/or to allow advertisement information stored via an external storage device, which corresponds to the location information, to be displayed through a displaying device installed inside and/or outside the vehicle, and thus, may provide an advertisement service according to the location. At this time, the displaying device may be a thin film-type flexible displaying device, and the advertisement information may be extracted in real time from the broadcast signal received through the broadcast network during a color-bars time and may be stored.

Specifically, in case the advertisement device included in the vehicle determines whether the advertisement information corresponding to the location information of the vehicle and determines that the advertisement information corresponding to the location information is stored, the advertisement device transmits the advertisement information to the displaying device installed inside and/or outside the vehicle and controls the advertisement information to be displayed. In case the advertisement information corresponding to the location information is not stored, the advertisement device sends a request for the advertisement information corresponding to the location information to the advertisement server through a communication network and downloads it from the advertisement server or may transmit streamed advertisement information to the displaying device so that the advertisement information is displayed.

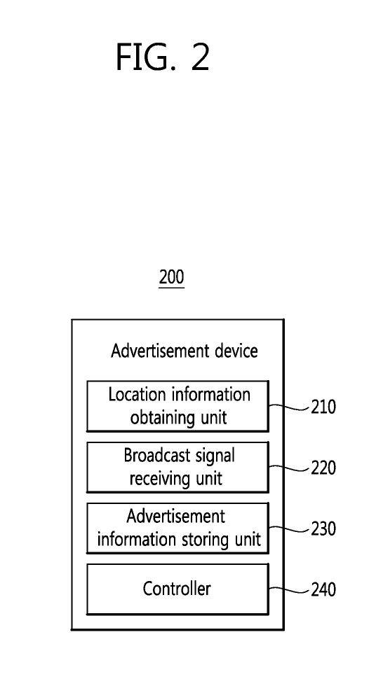

FIG. 2 is a block diagram illustrating an advertisement device according to an embodiment of the present invention. Hereinafter, referring to FIG. 2, the advertisement device according to the present invention is described in detail.

As shown in FIG. 2, the advertisement device 200 according to the present invention may include a location information obtaining unit 210, a broadcast signal receiving unit 220, an advertisement information storing unit 230, and a controller 240.

The location information obtaining unit 210 obtains location information of a vehicle, such as a bus or taxi, where the advertisement device 200 is mounted. By way of example, the location information obtaining unit 210 includes a GPS receiver or WiFi receiver and may receive GPS information from the GPS or WiFi information from a WiFi AP installed on a road or station. The location information obtaining unit 210 may calculate the location information of the vehicle where the advertisement device 200 is mounted based on the received GPS information or WiFi information and may keep grasping the current location.

The broadcast signal receiving unit 220 receives a broadcast signal including advertisement information through a broadcast network. At this time, NTR transmission technology may apply to the broadcast signal so that the advertisement information may be included therein.

The advertisement information storing unit 230 stores advertisement information extracted from the broadcast signal received by the broadcast signal receiving unit 220. The advertisement information stored in the advertisement information storing unit 230 may be extracted from the broadcast signal by the controller 240 and the advertisement information may include information on the region, date, or time of exposure of the corresponding advertisement.

The controller 240 determines whether advertisement information corresponding to the location information obtained by the location information obtaining unit 210 is stored in the advertisement information storing unit 230 and enables the advertisement information to be displayed through a displaying device installed inside and/or outside the vehicle where the broadcast signal receiving unit 220 is mounted.

By way of example, the controller 240, in case the advertisement information corresponding to the location information obtained by the location information obtaining unit 210 is present in the advertisement information storing unit 230, may enable the corresponding advertisement information to be displayed through the displaying device installed inside or outside the vehicle. However, upon determining that the advertisement information corresponding to the location information obtained by the location information obtaining unit 210 is not present in the advertisement information storing unit 230, the controller 240 may enable advertisement information corresponding to the location information to be downloaded from an advertisement server through a communication network or to be streamed so that the advertisement information may be transmitted to the displaying device.

Meanwhile, in case among the advertisement information stored in the advertisement information storing unit 230, a plurality of advertisement information corresponding to the location information obtained by the location information obtaining unit 210 is searched, the controller 240 may select advertisement information to be displayed through the displaying device among the searched advertisement information based on information on region, date and time as included in the advertisement information.

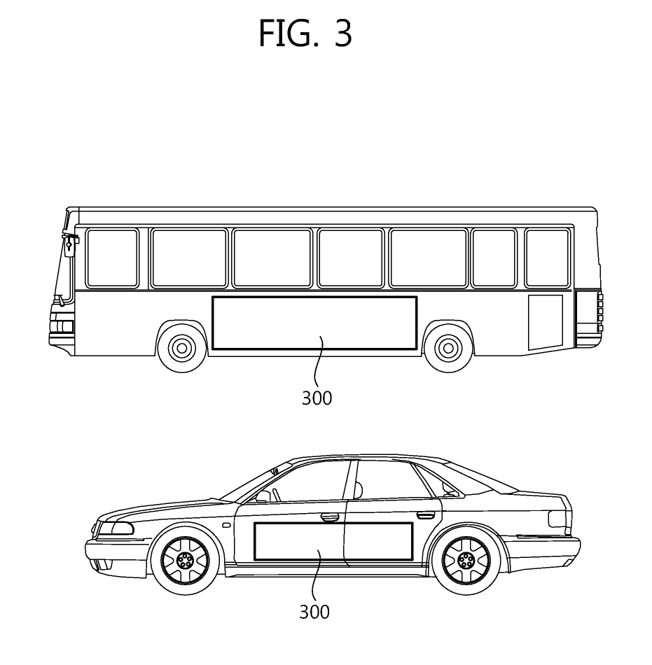

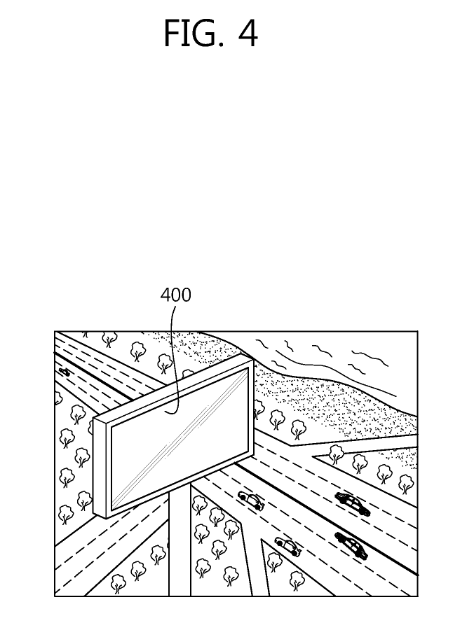

FIGS. 3 and 4 are views illustrating displaying devices displaying advertisement information according to embodiments of the present invention.

As an example, FIG. 3 illustrates a displaying device 300 installed outside a bus or taxi, and FIG. 4 illustrates a displaying device 400 installed outdoors.

An advertisement device according to the present invention, as described above in connection with FIGS. 1 and 2, may display advertisement information based on the location of a vehicle, such as a bus or taxi, through the displaying device 300 installed outside the vehicle, so that the optimum advertisement may be provided to a number of unspecified persons in a region.

Further, an advertisement device according to the present invention may be applied to various advertisement media such as the displaying device 400 installed outdoors, so that customized advertisements may be provided to consumers per region depending on the time or date related to consumption patterns.

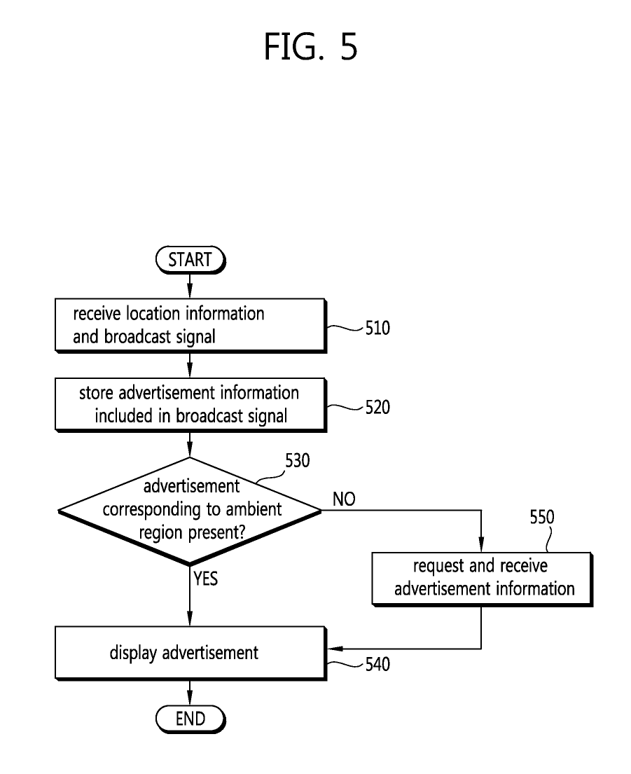

FIG. 5 is a flowchart illustrating a method of providing an advertisement service depending on location according to an embodiment of the present invention. Hereinafter, a method of providing an advertisement service according to the present invention is described in detail with reference to FIG. 5.

The advertisement device is mounted on a vehicle such as a bus or taxi so as to provide advertisement information depending on the location of the vehicle, obtains location information of the vehicle using GPS information or WiFi information, and receives a broadcast signal including advertisement information through a broadcast network (510). The advertisement device extracts the advertisement information from the received broadcast signal and stores the extracted advertisement information (520).

If the location information of the vehicle is obtained, the advertisement device determines whether advertisement information corresponding to the ambient region is stored (530). If the advertisement information is stored, the advertisement device enables the advertisement information to be displayed through a displaying device installed inside and/or outside the vehicle where the advertisement device is mounted (540). However, if it is determined that the advertisement information corresponding to the ambient region is not stored, the advertisement device sends a request for advertisement information corresponding to the region to an advertisement server through a communication network and receives the advertisement information (550), and enables the received advertisement information to be transmitted to the displaying device.

At this time, upon searching a plurality of advertisement information corresponding to the ambient region among the advertisement information previously stored, the advertisement device may select advertisement information to be displayed through the displaying device based on information on the region, date, and time included in each of the advertisement information.

Although embodiments of the present invention have been described with reference to the accompanying drawings, it is understood by those of ordinary skill in the art that various modifications may be made thereto without departing from the scope or spirit of the present invention.

What is claimed is:

1. An advertisement device providing an advertisement service depending on location, the advertisement device comprising:
a location information obtaining unit configured to obtain location information of a vehicle;
a broadcast signal receiving unit configured to receive a broadcast signal including advertisement information through a broadcast network;
an advertisement information storing unit configured to store the advertisement information included in the broadcast signal; and
a controller configured to enable the advertisement information corresponding to the location information to be displayed through a displaying device installed inside or outside the vehicle.

2. The advertisement device of claim 1, wherein the advertisement device is installed inside or outside the vehicle, and wherein the displaying device is a thin film-type flexible displaying device.

3. The advertisement device of claim 1, wherein the advertisement information is in real time extracted from the broadcast signal received through the broadcast network during a test signal time and is stored.

4. The advertisement device of claim 1, wherein the controller comprises, a determining module configured to determine whether the advertisement information corresponding to the location information is stored in the storing unit;
a requesting module configured to, in a case where the advertisement information corresponding to the location information is not stored in the storing unit, sends a request for the advertisement information corresponding to the location information to an advertisement server through a communication network; and
a transmission module configured to transmit the advertisement information received from the advertisement server to the displaying device so that the advertisement information corresponding to the location information is displayed through the displaying device.

5. The advertisement device of claim 1, wherein the controller is configured to enable the advertisement information corresponding to the location information to be displayed through the displaying device installed inside the vehicle.

6. A method of providing an advertisement service depending on location, the method comprising:
obtaining location information of a vehicle by an advertisement device;
receiving a broadcast signal including advertisement information through a broadcast network;
storing the advertisement information included in the broadcast signal; and
enabling the advertisement information corresponding to the location information to be displayed through a displaying device installed inside or outside the vehicle.

7. The method of claim 6, wherein the advertisement device is installed inside or outside the vehicle, and wherein the displaying device is a thin film-type flexible displaying device.

8. The method of claim 6, wherein the advertisement information is in real time extracted from the broadcast signal received through the broadcast network during a test signal time and is stored.

9. The method of claim 6, wherein said enabling comprises,
determining whether the advertisement information corresponding to the location information is stored in the storing unit;
in a case where the advertisement information corresponding to the location information is not stored in the storing unit, sending a request for the advertisement information corresponding to the location information to an advertisement server through a communication network; and
transmitting the advertisement information received from the advertisement server to the displaying device so that the advertisement information corresponding to the location information is displayed through the displaying device.

10. The method of claim 6, wherein said enabling comprises enabling the advertisement information corresponding to the location information to be displayed through the displaying device installed inside the vehicle.
